(19) United States
(12) Patent Application Publication
(10) Pub. No.: US 2012/0143569 A1
(43) Pub. Date: Jun. 7, 2012

(54) Automated Extraction of Size-Dependent Layout Parameters for Transistor Models

(75) Inventors: Oluwamuyiwa Oluwagbemiga Olubuyide, Plano, TX (US); Donald Mark Kolarik, Murphy, TX (US)

(73) Assignee: TEXAS INSTRUMENTS INCORPORATED, Dallas, TX (US)

(21) Appl. No.: 12/959,830

(22) Filed: Dec. 3, 2010

(51) Int. Cl. G06F 17/50; G06F 9/455

(52) U.S. Cl. 703/1; 716/112; 703/14

(57) ABSTRACT

A system and method for determining transistor model parameters that account for layout-dependent features in the transistor being modeled, and also in neighboring devices in the same integrated circuit. A computer-readable expression of the integrated circuit layout is retrieved, and active and gate layers in that expression extracted. For a transistor being modeled, its active regions are analyzed to determine whether these regions have a complex shape. Model parameters are derived based on volume effects of the complex shaped active regions. Neighboring active regions that affect parameters of the transistor being modeled are also identified and their effective depth determined. Strain effects due to complex shaped active regions and neighboring elements are thus included in the transistor model.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

This invention is in the field of simulation of integrated circuits, and is more specifically directed to the modeling of metal-oxide-semiconductor (MOS) transistor performance including the effects of structure layout, as applied to such simulation.

Simulation of the operation of electronic circuits is a staple task in the design of integrated circuits, even for the most simple of functions but especially as integrated circuit functionality and complexity have increased over time. Modern circuit simulation tools not only allow the circuit designer to verify that a circuit carries out its intended function, but also enable the designer to evaluate the robustness of circuit operation over variations in temperature, signal levels, power supply voltages, and process parameters. A well-known circuit simulation program is the Simulation Program with Integrated Circuit Emphasis, commonly referred to as SPICE, originated at the Electronics Research Laboratory of the University of California, Berkeley. Many commercial versions of the SPICE program are now available in the industry, including versions that are proprietary to integrated circuit manufacturers.

According to SPICE-based circuit simulators, the circuit being simulated is expressed in terms of its elements such as resistors, transistors, capacitors, and the like. Each circuit element is associated with a model of its behavior (i.e., response to voltage or current stimuli), and is “connected” into the overall circuit simulation by specifying the circuit nodes to which it is connected. Steady-state (DC), small-signal response (AC), or transient analysis of the circuit is then performed by specifying any initial conditions (voltages, currents, stored charge etc.), as well as the variable or node of interest, for which the circuit response is to be analyzed. Higher level analysis of the circuit, for example noise analysis, transfer functions, and the like, can also be performed via such simulation.

The models used for semiconductor devices in the simulation can be relative simple circuit-based models, for example corresponding to the well-known Ebers-Moll or Gummel-Poon models. However, models based on device physics have now been derived that determine the device electrical characteristics according to physical parameters such as channel width, channel length, film or layer thicknesses, proximity to other devices, and the like. Such physical models can be correlated or combined with complex empirical electrical models derived from curve fitting to actual device electrical measurements, further improving (at least in theory) the precision with which the behavior of the circuit element can be simulated.

Recent advances in semiconductor technology as applied to integrated circuits include the use of “strain engineering” (or, alternatively, “stress engineering”) in the manufacture of semiconductor device structures. It has been discovered that the tuning of strain in the crystal lattice of metal-oxide-semiconductor (MOS) transistor channel regions can enhance carrier mobility in those regions. As is fundamental in MOS device technology, the source/drain current (i.e., drive) of an MOS transistor in both the triode and saturation regions is proportional to carrier mobility in the channel region. In a general sense, compressive stress enhances hole mobility in the channel region of a p-channel MOS transistor, and tensile stress enhances electron mobility in the channel region of an n-channel MOS transistor. Typically, p-channel MOS transistors exhibit lower drive capability than n-channel MOS transistors in typical modern integrated circuits. As such, strain engineering techniques are more typically applied to p-channel MOS transistors than to n-channel MOS transistors, in current day manufacturing technology.

Various strain engineering approaches are known in the art. According to the approach known as “embedded SiGe” (also referred to as “eSiGe”), the source and drain regions of a p-channel MOS transistor structure are etched from the silicon substrate or well region, and are replaced with a silicon-germanium alloy formed by selective epitaxy. Because of the germanium atoms within the silicon crystal lattice, the germanium constituting as much as 30% (atomic) of the alloy, eSiGe exhibits a larger lattice constant than does silicon (i.e., the distance between unit cells in the crystal lattice for SiGe is greater than in single-crystal silicon). Embedded eSiGe source/drain regions thus apply compressive stress to the channel region of the p-channel MOS transistor being formed. This compressive stress in the channel increases the hole mobility of the p-channel MOS transistor, and enhances its performance.

Another conventional strain engineering approach is referred to in the art as “dual stress liner”, or “DSL”, technology. According to this approach, a silicon nitride layer of either tensile or compressive characteristics is deposited over the surface of the integrated circuit, and patterned and etched to remain only over the active regions (i.e., source and drain regions) of transistors that are to receive the resulting stress. Tensile silicon nitride is used to enhance n-channel MOS transistors, and compressive silicon nitride is used to enhance p-channel MOS transistors. Both types of nitride layers can be used in CMOS integrated circuits, so that transistors of both conductivity types benefit.

It has been observed that the effect of channel region strain on transistor performance depends upon the volume of strain-inducing material (whether in the form of embedded SiGe or as a stress liner) in the active region of the transistor. In addition, the volume of strain-inducing material deployed at nearby active regions has also been observed to affect transistor performance. These effects have not been accurately incorporated into transistor models, beyond the ability of some conventional modeling tools to identify the presence of nearby active regions to the modeled transistor, and in some cases the distance between the modeled transistor and its neighboring active region. Such tools have been observed to not fully model the effect of these modern strain engineering techniques.

As is well known in the art, many modern integrated circuits including hundreds of thousands of high-performance transistors. Accurate simulation of the operation and performance of these complex large-scale devices is critical in the design and debug phases of the product life cycle, and is critical to economic success. However, the large number of transistors and the complex layout of these devices in some realizations greatly complicate the ability of the device models and simulation to fully comprehend layout-dependent effects, such as the strain engineering effects described above.

### BRIEF SUMMARY OF THE INVENTION

Embodiments of this invention provide an automated system and method of operating the same that extracts layout-dependent parameters that can affect the performance of a given transistor in an integrated circuit, for use in modeling and simulation.

Embodiments of this invention provide such a system and method in which irregular layout features in active regions of the transistor being modeled are detected and characterized for stress effects on the transistor channel region.

Embodiments of this invention provide such a system and method in which neighboring active regions to those of the transistor being modeled are detected and characterized for stress effects on the channel region of the transistor being modeled.

Embodiments of this invention provide such a system and method in which active regions neighboring those of the transistor being modeled are detected in multiple directions.

Other objects and advantages of embodiments of this invention will be apparent to those of ordinary skill in the art having reference to the following specification together with its drawings.

Embodiments of this invention may be implemented by way of a programmed computer system, and method of operating the same, in which integrated circuit layout features are identified and characterized for their effect on stress-dependent transistor parameters, for example as applied to a model of the transistor as useful in simulation systems. From an integrated circuit layout database, particular layers of interest including n-type and p-type active regions, gate, contact, and metal levels are extracted. For each transistor of interest, the layout is scanned to identify particular features that affect transistor performance. Those features are characterized for proximity and depth, with the characterization results affecting a performance parameter for the transistor of interest.

According to one aspect of the invention, the system identifies features in the active region of the transistor of interest itself. For each layer of interest, the layout is scanned beginning from a corner of the gate structure at an edge of the active region, until an inflection point (e.g., a corner) is detected. The scan is continued, and if another corner is detected before the far edge of the active region or a gate electrode in a neighboring transistor, a jog feature is identified. Dimensions of the jog feature are characterized, and a corresponding adjustment factor is applied to transistor parameters accordingly.

According to another aspect of the invention, the system identifies nearby features to the transistor of interest. For the active region layers, and within a window of interest, the layout is scanned in both a direction parallel to the gate structure and also in a direction perpendicular to the gate structure, to determine whether an active region of a neighboring device is present. If so, the effective depth of the neighboring active region is characterized, and applied to transistor parameters accordingly.

### BRIEF DESCRIPTION OF THE SEVERAL VIEWS OF THE DRAWING

FIG. 1 is an electrical diagram, in schematic form, illustrating a computer system for modeling a metal-oxide-semiconductor (MOS) transistor, and for simulating an integrated circuit including such a modeled transistor, according to embodiments of the invention.

FIG. 2 is a generalized flow diagram illustrating the operation of the system of FIG. 1 according to embodiments of this invention.

FIG. 3a is a cross-sectional view of a MOS transistor illustrating the effect of embedded silicon-germanium on the transistor channel region.

FIGS. 3b and 3c are plan views of MOS transistors having source and drain regions of complex shape, the effects of which are modeled according to embodiments of this invention.

FIG. 4 is a flow diagram illustrating the operation of the computer system in modeling the effects of complex source/drain shapes on the performance of a MOS transistor, according to embodiments of the invention.

FIGS. 5a and 5b are plan views of MOS transistors having source and drain regions of complex shape, illustrating the operation of the layout extraction in the modeling process of FIG. 4 according to embodiments of this invention.

FIGS. 6a and 6b are plan views of a MOS transistor and neighboring active regions, in which the proximity of the neighboring active regions affects the performance of the MOS transistor.

FIG. 7 is a flow diagram illustrating the operation of the computer system in modeling the proximity effects of neighboring active regions and intervening isolation dielectric structures on the performance of a MOS transistor, according to embodiments of the invention.

FIG. 8 is a plot illustrating the effectiveness of transistor current modeling according to embodiments of this invention, as compared with conventional modeling and with actual transistor measurements.

### DETAILED DESCRIPTION OF THE INVENTION

This invention will be described in connection with one or more of its embodiments, namely as implemented into a computer system programmed to model the performance of metal-oxide-semiconductor (MOS) transistors for the effects of layout parameters, as it is contemplated that this invention will be especially beneficial when applied in such a manner. However, it is contemplated that the layout extraction performed according to this invention will be beneficial in modeling a wide range of integrated circuit devices for various effects other than those described herein. Accordingly, it is to be understood that the following description is provided by way of example only, and is not intended to limit the true scope of this invention as claimed.

Modeling and Simulation System

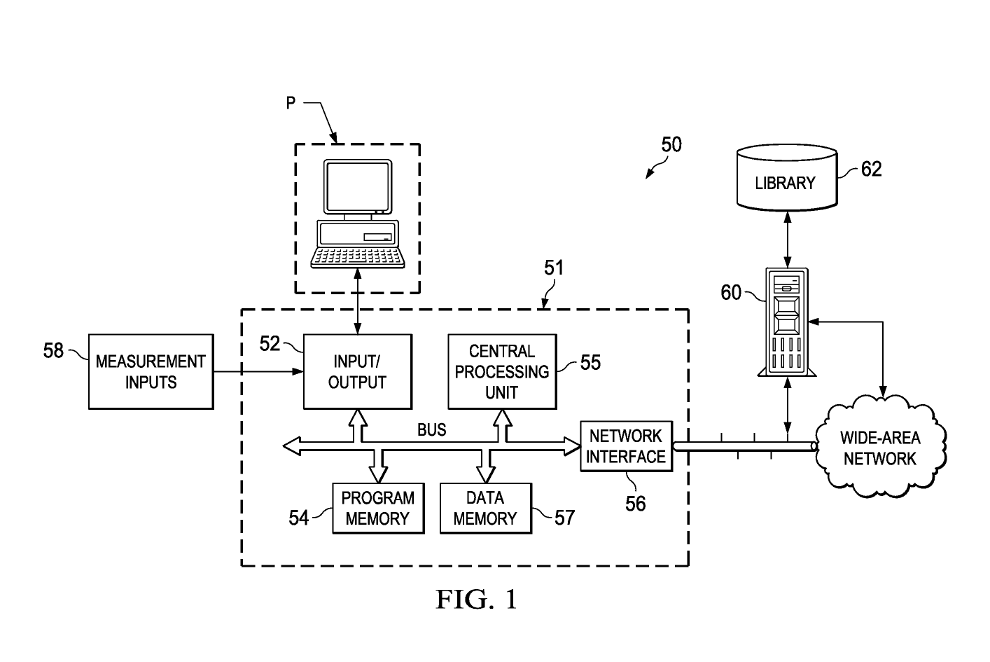

Referring to FIG. 1, computing system 50 for deriving and storing a transistor model generated according to embodiments of this invention, and for applying that model in the simulation of an electronic circuit including a transistor modeled will now be described.

FIG. 1 illustrates the construction of modeling and simulation system 50 according to an example of an embodiment of the invention. Modeling and simulation system 50 performs the operations described below in this specification to model one or more transistors in an integrated circuit, and to simulate the behavior of that transistor or transistors in an electronic circuit. In this example, modeling and simulation system 50 is as realized by way of a computer system including workstation 51 connected to server 60 by way of a network. Of course, the particular architecture and construction of a computer system useful in connection with this invention can vary widely. For example, modeling and simulation system 50 may be realized by a single physical computer, such as a conventional workstation or personal computer, or alternatively by a computer system implemented in a distributed manner over multiple physical computers. Accordingly, the generalized architecture illustrated in FIG. 1 is provided by way of example only.

As shown in FIG. 1, workstation 51 includes central processing unit 55, coupled to system bus BUS. Also coupled to system bus BUS is input/output interface 52, which refers to those interface resources by way of which peripheral functions P (e.g., keyboard, mouse, display, etc.) communicate with the other constituents of workstation 51. Central processing unit 55 refers to the data processing capability of workstation 51, and as such may be implemented by one or more CPU cores, co-processing circuitry, and the like. The particular construction and capability of central processing unit 55 is selected according to the application needs of workstation 51, such needs including, at a minimum, the carrying out of the functions described in this specification, and also including such other functions as may be desired to be executed by modeling and simulation system 50. In the architecture of modeling and simulation system 10 according to this example, program memory 54 and data memory 57 are coupled to system bus BUS.

Program memory 54 stores the computer instructions to be executed by central processing unit 55 in carrying out those functions. More specifically, program memory 54 is a computer-readable medium storing executable computer program instructions according to which the operations described in this specification are carried out by modeling and simulation system 50, specifically by central processing unit 55 of workstation 51. Alternatively, these computer program instructions may be stored at and executed by server 60, in the form of a “web-based” application, upon input data communicated from workstation 51, to create output data and results that are communicated to workstation 51 for display or output by peripherals P in a form useful to a human user. Data memory 57 provides memory resources of the desired type useful as data memory for storing input data and the results of processing executed by central processing unit 55. Of course, this memory arrangement is only an example, it being understood that data memory 57 and program memory 54 may be included within a unified physical memory resource, or distributed in whole or in part outside of workstation 51. In addition, as shown in FIG. 1, measurement inputs 58 that are acquired from laboratory tests and measurements, or as design parameters, are input via input/output function 52, and stored in a memory resource accessible to workstation 51, either locally or via network interface 56.

Network interface 56 of workstation 51 is a conventional interface or adapter by way of which workstation 51 accesses network resources on a network. As shown in FIG. 1, the network resources to which workstation 51 has access via network interface 56 includes server 60, which resides on a local area network, or on a wide-area network such as an intranet, a virtual private network, or over the Internet, and which is accessible to workstation 51 by way of one of those network arrangements and by corresponding wired or wireless (or both) communication facilities. In this embodiment of the invention, server 60 is a computer system, of a conventional architecture similar, in a general sense, to that of workstation 51, and as such includes one or more central processing units, system buses, and memory resources, network interface functions, and the like. Library 62 is also available to server 60 (and perhaps workstation 51 over the local area or wide area network), and stores model calculations, previous model results, actual electrical measurements for use in correlation with current models, and other archival or reference information useful in modeling and simulation system 50. Library 62 may reside on another local area network, or alternatively be accessible via the Internet or some other wide area network. It is contemplated that library 62 may also be accessible to other associated computers in the overall network.

Of course, the particular memory resource or location at which the measurements, library 62, and program memory 54 physically reside can be implemented in various locations accessible to modeling and simulation system 50. For example, these data and program instructions may be stored in local memory resources within workstation 51, within server 60, or in remote memory resources that are network-accessible to these functions. In addition, each of these data and program memory resources can itself be distributed among multiple locations, as known in the art. It is contemplated that those skilled in the art will be readily able to implement the storage and retrieval of the applicable measurements, models, and other information useful in connection with this embodiment of the invention, in a suitable manner for each particular application.

According to this embodiment of the invention, by way of example, program memory 54 stores computer instructions executable by central processing unit 55 to carry out the functions described in this specification, by way of which the construction of a modeled example of one or more transistors can be evaluated. These computer instructions may be in the form of one or more executable programs, or in the form of source code or higher-level code from which one or more executable programs are derived, assembled, interpreted or compiled. Any one of a number of computer languages or protocols may be used, depending on the manner in which the desired operations are to be carried out. For example, these computer instructions may be written in a conventional high level language, either as a conventional linear computer program or arranged for execution in an object-oriented manner. These instructions may also be embedded within a higher-level application. For example, it is contemplated that the model described herein is especially useful when applied to an electronic circuit simulation using a simulation environment based on the well-known Simulation Program with Integrated Circuit Emphasis, commonly referred to as SPICE, originated at the Electronics Research Laboratory of the University of California, Berkeley. Many commercial versions of the SPICE program are now available in the industry, including several versions that are internal or proprietary to integrated circuit manufacturers.

Alternatively, these computer-executable software instructions may be resident elsewhere on the local area network or wide area network, or downloadable from higher-level servers or locations, by way of encoded information on an electromagnetic carrier signal via some network interface or input/output device. The computer-executable software instructions may have originally been stored on a removable or other non-volatile computer-readable storage medium (e.g., a DVD disk, flash memory, or the like), or downloaded as encoded information on an electromagnetic carrier signal, for example in the form of a software package from which the computer-executable software instructions were installed by modeling and simulation system 50 in the conventional manner for software installation. It is contemplated that those skilled in the art having reference to this description will be readily able to realize, without undue experimentation, this embodiment of the invention in a suitable manner for the desired installations.

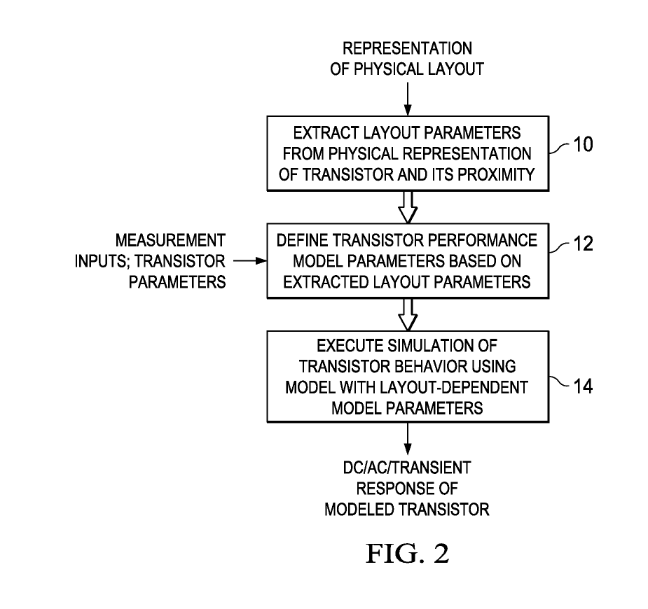

FIG. 2 illustrates the general operation of modeling and simulation system 50 according to embodiments of this invention. Workstation 51 receives or otherwise accesses a representation of the physical layout of the integrated circuit to be modeled and simulated (e.g., from library 62 via network interface 56). This physical layout representation can be received in any number of conventional formats, including the well-known .gds and .laff files, and includes such information as the size and position of features in the integrated circuit. Typically, as known in the art, this representation is conveyed in the form of multiple “layers”, each corresponding to a physical layer in the eventual integrated circuit. Many of these layers in the layout representation correspond to physical features that are defined in the eventual integrated circuit by photolithographic patterning and etch of deposited films or other structural layers. Examples of these layers in the received representation of the integrated circuit layout include wells (n-well and p-well), active regions, gate (e.g., polysilicon), contact openings, and one or more metal or other conductor layers.

In process 10 shown in FIG. 2, workstation 51 in modeling and simulation system 50 executes a computer program stored in its program memory 54 to extract certain layout parameters from the physical layout representation of one or more transistors to be modeled. As will be described in further detail in this specification, these layout parameters include size-dependent parameters that indirectly affect the performance of the transistor to be modeled. For the example of metal-oxide-semiconductor (MOS) transistors, discussed in this specification, the size-dependent parameters include the shape and location of active regions from which the source and drain of the transistor is formed, and also the distance and depth of active regions neighboring the transistor to be modeled, both of which have been observed in some cases to apply a strain to the MOS transistor channel region sufficient to change one or more electrical parameters in that transistor. In a general sense, the size-dependent parameters are characterized by a distance of a particular feature from the channel region of the transistor being modeled, and also the depth of that particular feature. The operation of process 10 in this regard will be described in further detail below.

As suggested in FIG. 1, various measurement inputs or design parameters 58 are provided to or accessed by workstation 51, from which various transistor performance parameters are calculated. Examples of these parameters include junction depth, resistivity (i.e., conductivity) of various conductive or semi-conductive materials, dielectric film thickness and dielectric constant, and the like. Alternatively or additionally, previously derived transistor performance parameters can be retrieved by workstation 51 from library 62, such parameters including mobility, threshold voltage, saturation velocity, on resistance, and the like.

Upon extraction of the layout parameters in process 10 and receipt of the physical or performance parameters, workstation 51 executes computer program instructions to define one or more transistor performance model parameters as affected by the extracted layout parameters, in process 12. In general, the particular performance parameters defined by process 12 include mobility, threshold voltage, saturation velocity, on resistance, and the like. Process 12 can operate by deriving these parameters directly from the layout parameters extracted in process 10 and measurement inputs 58, or alternatively by modifying or adjusting previously-derived performance parameters for the effects of the extracted layout parameters. This process 12 is applied to one or more transistors of interest, depending on the modeling and simulation to be performed.

The particular computer program executed by workstation 51 to carry out process 12 may be a conventional device modeling software package such as the ASSURA physical verification software package available from Cadence Design Systems, Inc., the STAR RC-XT software package available from Synopsys, Inc., and the like, into or with which a plug-in or other adaptation (including a stand-alone extraction program) is provided for carrying out layout-dependent extraction according to embodiments of this invention described in this specification. It is contemplated that those skilled in the art having reference to this specification can readily realize such plug-ins or adaptations as appropriate, without undue experimentation.

Following the definition of transistor performance model parameters in process 12, modeling and simulation system 50 then performs process 14 to carry out the desired electrical simulation of the integrated circuit, including one or more transistors of interest for which the transistor performance model parameters have been derived or adjusted according to the extracted layout parameters. Process 14 may be performed by workstation 51, server 60, or some other resource in modeling and simulation system 50 as the case may be, executing computer program instructions stored in the appropriate program memory for the operative computing resources. The simulation of process 14 may include DC simulation (i.e., steady-state or operating point determination), AC simulation (i.e., small-signal response), the simulation of transient response to switching stimulation, or a combination of these and other electrical behaviors, as desired by the personnel directing the simulation. As a result of the layout parameter extraction of process 10, as will be described below, the effects of channel region strain applied by the shape and size of various features in the integrated circuit are taken into account, rendering a more accurate simulation, and thus eventually a more robust and higher performance integrated circuit.

Modeling Effects Due to Source/Drain Regions of Complex Shape

Active regions serving as the source and drain regions of an MOS transistor and that are of complex shape constitute one type of size-dependent layout feature that affects the electrical performance of that transistor, particularly in cases in which strain engineering techniques are implemented. As mentioned above in connection with the Background of the Invention, one type of strain engineering technique involves the embedding of epitaxial silicon alloy into the source and drain regions of an MOS transistor. Source and drain regions of a silicon alloy material having a greater lattice constant than silicon exert a compressive stress on the channel region, which enhances carrier mobility in p-channel MOS transistors. Silicon-germanium is an example of such a material. Conversely, source and drain regions of a silicon alloy material having a lower lattice constant than silicon exert a tensile stress on the channel region, which enhances carrier mobility in n-channel MOS transistors; silicon-carbon is an example of a lower lattice constant silicon alloy.

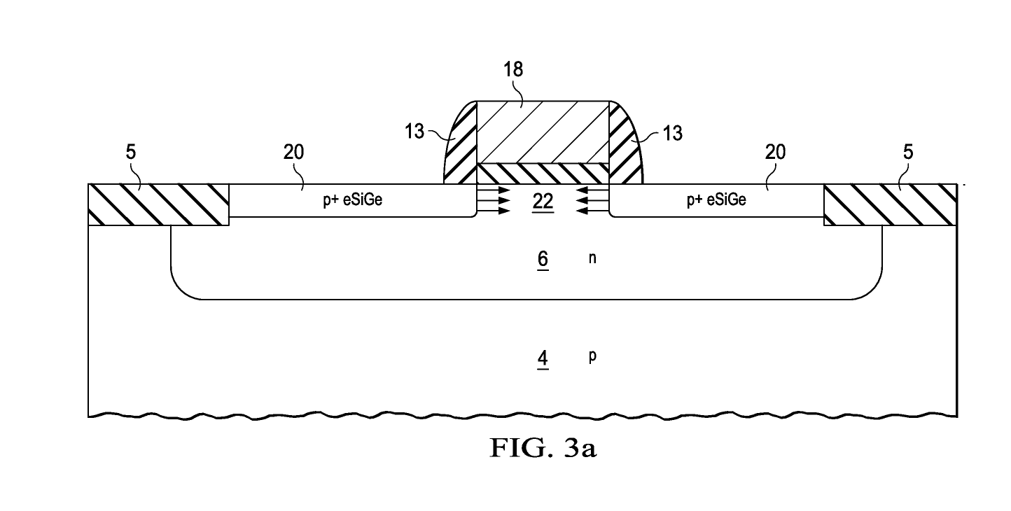

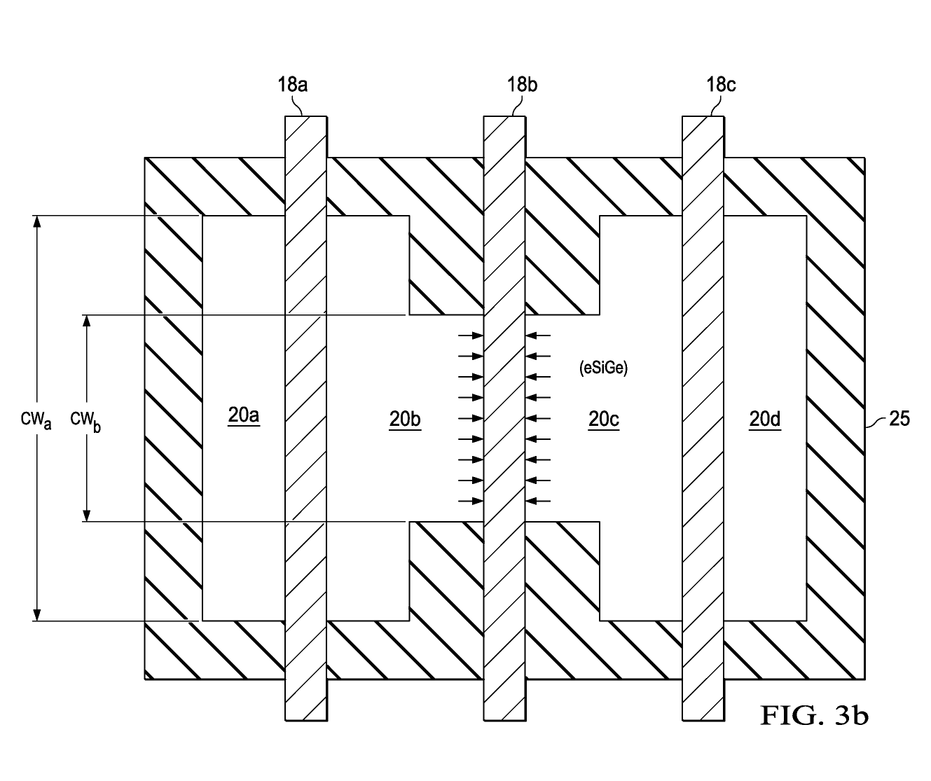

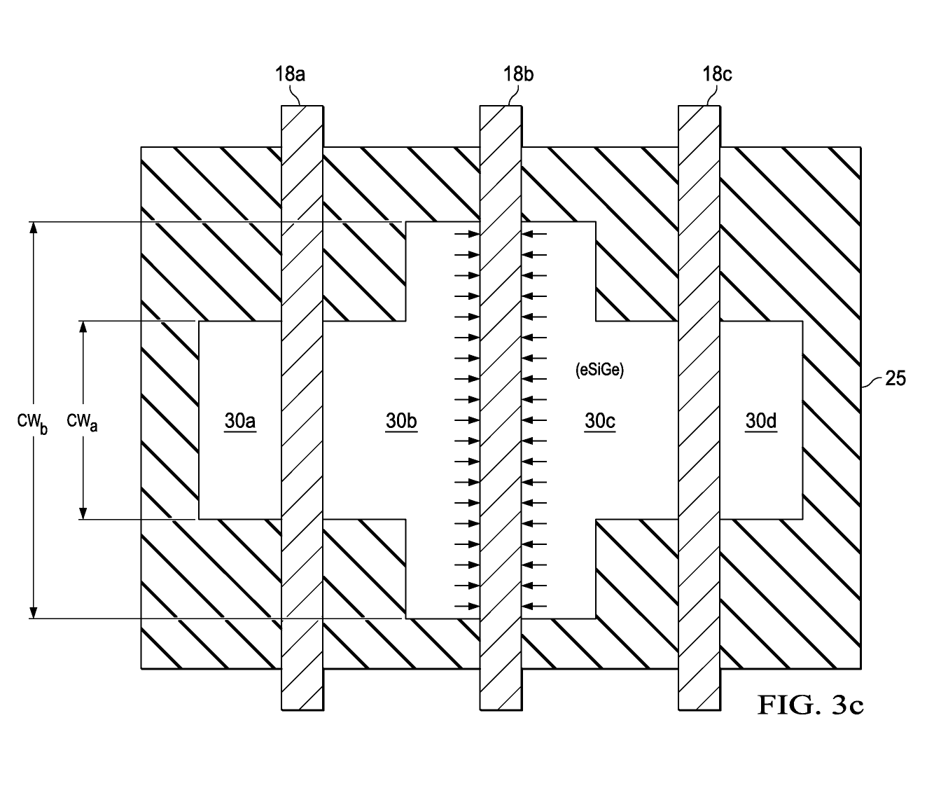

FIG. 3a illustrates, in cross section, a conventional p-channel MOS transistor including embedded silicon-germanium (“eSiGe”) source/drain regions. In this example, the transistor is formed at the surface of n-well 6 formed at a selected location of p-type substrate 4, in the conventional manner. Shallow trench isolation structures 5 are disposed at selected locations of the surface of substrate 4, and isolate the active transistor regions from one another. Polysilicon gate electrode 18 is disposed over this the active region between isolation structures 5, overlying channel region 22 in n-well 6, with gate dielectric 7 disposed therebetween. Sidewall spacers 13 are disposed on the sides of gate electrode 8, formed in the conventional manner by deposition of a silicon dioxide or silicon nitride layer and anisotropic etch of that layer.

As shown in FIG. 3a, embedded SiGe source/drain structures 20 are disposed on either side of gate electrode 8. As known in the art, eSiGe structures 20 are formed by selective epitaxy of a silicon-germanium alloy into recesses etched into the underlying single-crystal silicon of n-well 6 in this example. The recess etch takes place in a somewhat self-aligned manner relative to gate electrode 8, with some amount of lateral undercut into channel region 22 desirable, as shown. SiGe structures 20 are typically doped in situ during the epitaxy, and also by subsequent ion implantation, to become heavily doped p-type, forming the source and drain regions of this transistor. These eSiGe structures 20 exert compressive strain on channel region 22 underlying gate electrode 8, because the presence of germanium atoms increases the lattice constant of SiGe structures 20 relative to the surrounding silicon. This compressive strain increases the mobility of holes in channel region 22, enhancing the current drive of this p-channel transistor when in an “on” state.

FIG. 3b illustrates, in plan view, an example of p-channel MOS transistors with eSiGe source/drain regions 20, in which the somewhat complex shape of those source/drain regions affects the performance of one or more of the transistors. In this example of FIG. 3b, the overall shape of the active region is an “H” shape, that active region defined by the portion of the surface of the integrated circuit at which shallow trench isolation structures 25 are not present. In this example, three polysilicon gate structures 18a, 18b, 18c extend across this active region, each extending onto isolation structures 25 on both sides of active region 20, and thus each forming a MOS transistor. As described above relative to FIG. 3a, source/drain regions 20a through 20d are located in this active region, at locations that are not covered by gate electrodes 18a, 18b, 18c, and are formed as embedded silicon-germanium (eSiGe). These eSiGe source/drain regions 20a through 20d serve as the source and drain regions of the three transistors formed by gate electrodes 18a, 18b, 18c, depending on the bias applied to source/drain regions 20a through 20d by way of metal conductors (not shown) and contact openings through overlying insulator layers.

As discussed above and as suggested by FIG. 3b, eSiGe source/drain regions 20a through 20d exert a compressive strain on the channel regions (not visible in FIG. 3b) underlying adjacent gate electrodes 18a, 18b, 18c. For p-channel MOS transistors as in this case, that compressive strain enhances the carrier mobility in the channel, and thus enhances the source/drain drive current of these transistors when turned on by the appropriate bias. In a general sense, the nominal carrier mobility enhancement due to the eSiGe source and drain regions is proportional to the physical channel width of the transistor, which of course corresponds to the length of the channel region underlying a gate electrode 18 that is in contact with the eSiGe source/drain regions 20. In the example of FIG. 3b, physical channel width CW_{b} for the transistor defined by gate electrode 18b is established by the length of the channel region underlying gate electrode 18b that is in contact with source/drain region 20b (which is the same, in this symmetric case, as the length in contact with source/drain region 20c).

For this transistor, however, it has been observed that the complex shape of active regions 20b, 20c in contact with the channel region underlying gate electrode 18b causes additional strain on that channel region beyond that indicated by physical channel width CW_{b}. In particular, the volume exerting the strain includes not only the portion of source/drain regions 20b, 20c in contact with the channel region, but also the wider portion of source/drain regions 20b, 20c that is not in contact with the channel region underlying gate electrode 18b (e.g., the portion of source/drain region 20b with width CWₐ). As such, an estimate of the carrier mobility enhancement that is based only on channel width CW_{b} would tend to underestimate the true mobility enhancement caused by the strain of eSiGe source/drain region 20b (and symmetric source/drain region 20c). According to embodiments of this invention, the size-dependent effect of the complex layout feature realized by the wider portion of source/drain regions 20b, 20c on the channel region underlying gate electrode 18b will be taken into account in deriving the carrier mobility of that transistor, for purposes of modeling and simulation.

FIG. 3c illustrates, in plan view, another instance in which the active regions affect the performance of a transistor. In this example, the active regions of a p-channel MOS transistor with eSiGe source/drain regions are in a “cross” shape. As in the case of FIG. 3b, shallow trench isolation structures 25 define the active region at which the transistors are formed, and gate electrodes 18a, 18b, 18c extend across that active region to define the transistors themselves. In this example as before, eSiGe source/drain regions 30a, 30b, 30c, 30d are formed alongside gate electrodes 18a, 18b, 18c in this active region, and serve as the source and drain for these MOS transistors.

Again, the strain effect of eSiGe source/drain regions 30b, 30c on the channel region underlying gate electrode 18b is nominally proportional to physical channel width CW_{b}, namely the length of this channel region that is in contact with source/drain regions 30b, 30c (assuming source and drain to be symmetric). However, source/drain region 30b narrows to a width of channel width CWₐ (for the transistor defined by gate electrode 18a), at a distance away from gate electrode 18b. As a result, less volume of eSiGe source/drain region 30b exerts strain on the channel region underlying gate electrode 18b than in the case if source/drain region 30b maintained a constant width CW_{b}. Accordingly, use of only the physical channel width CW_{b} to determine the mobility enhancement effect of eSiGe source/drain region 30b would overestimate that enhancement. According to embodiments of this invention, the size-dependent effect of the complex layout feature realized by the narrower portion of source/drain regions 30b, 30c will be taken into account in deriving the carrier mobility of that transistor, for purposes of modeling and simulation.

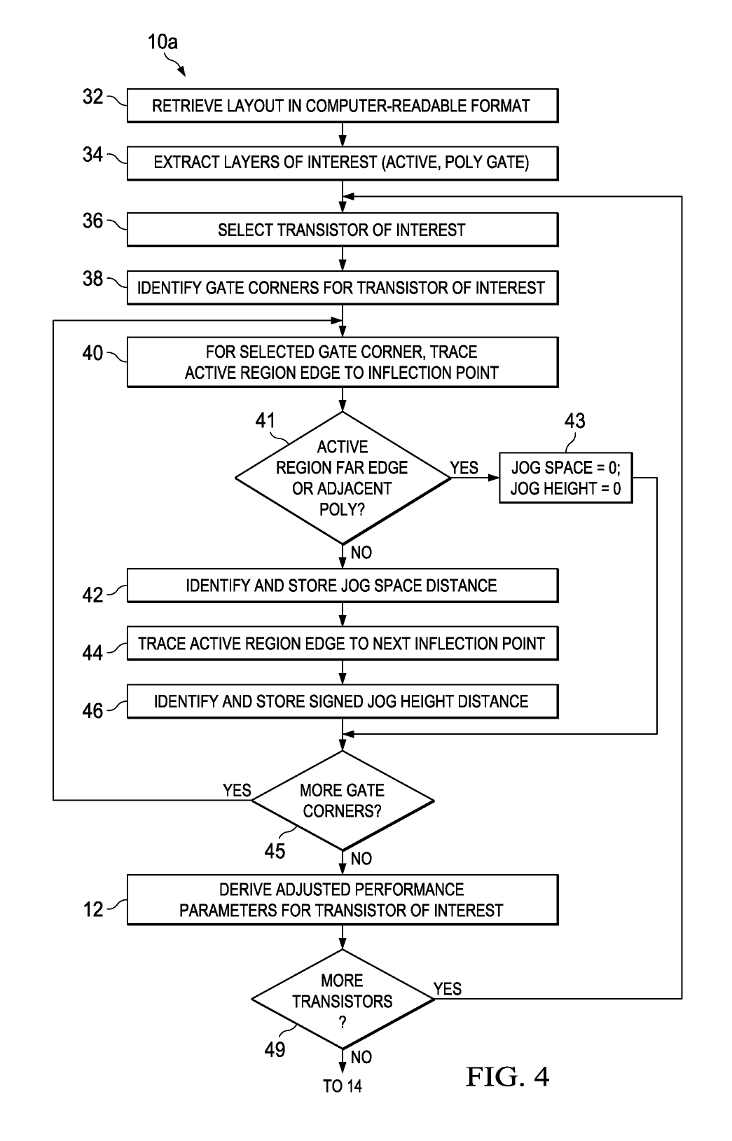

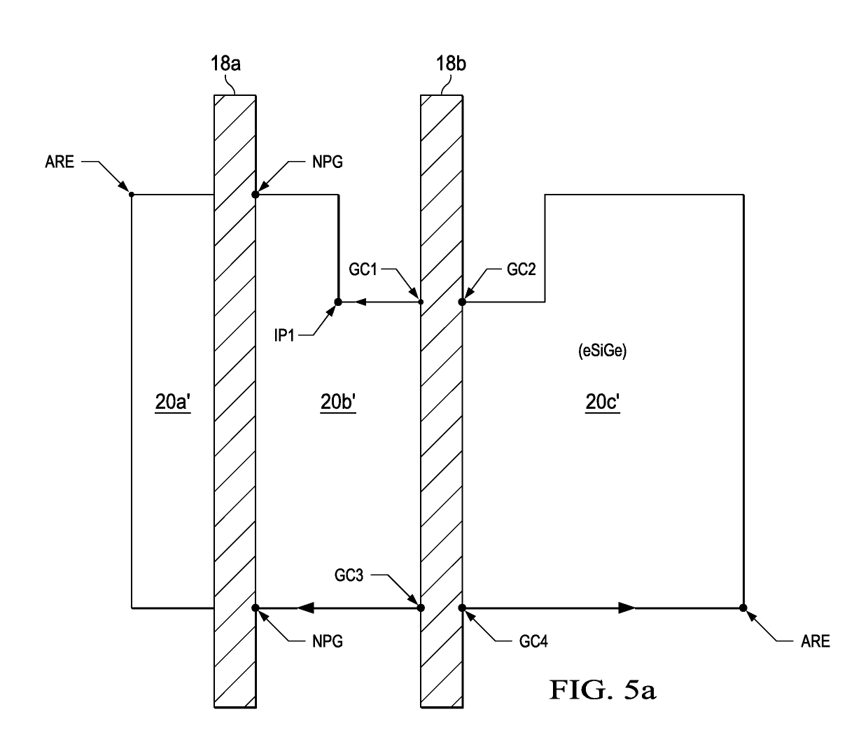

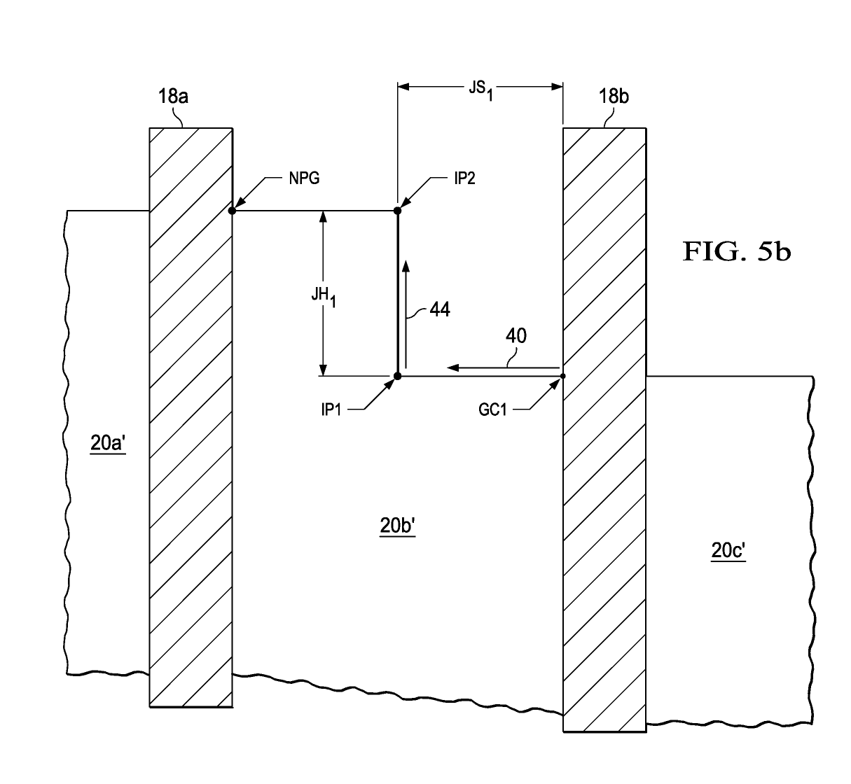

Referring now to FIG. 4, the detailed operation of layout extraction process 10a in extracting layout-dependent information regarding the complex shape of active regions such as those described above in connection with FIGS. 5a and 5b will now be described. Layout extraction process 10a of this embodiment of the invention is contemplated to be implemented as part of overall layout extraction process 10 (FIG. 2). As mentioned above, it is contemplated that computing resources in modeling and simulation system 50 will carry out this operation by executing computer program instructions, whether stored locally in one or more memory resources operating as programmed memory or by way of invoking the execution of a web-based application, or the like. By way of example, in the following description, process 10a will be described as executed, in large part, by workstation 51 in modeling and simulation system 50; of course, other computing resources in modeling and simulation system 50 can alternatively perform these operations. As such, it is contemplated that those skilled in the art having reference to this specification will recognize that these various process steps can be carried out in this computer-based manner, even if the following description does not specifically refer to modeling and simulation system 50 as executing a particular step or steps. It is also contemplated that process 10a can include other operations and process steps beyond those shown in FIG. 4 and described herein, as will become expressly apparent from this specification in connection with other embodiments of this invention.

Process 10a of FIG. 4 begins with process 32, in which a computer-readable expression of the layout of at least a portion of an integrated circuit is retrieved. For example, referring to FIG. 1, workstation 51 of modeling and simulation system 50 may carry out process 32 by retrieving a layout data file from library 62, via server 60 and network interface 56. Examples of the format of the layout information retrieved in process 32 include the well-known .gds and .laff file formats, as used by conventional computer-aided design programs. This computer-readable expression of the integrated circuit layout may have originally been created in that form, or may be converted into that computer-readable form from another format.

As discussed above relative to FIG. 2, the layout data file retrieved in process 32 typically expresses the layout information in the form of various layers related to the eventual construction of the integrated circuit. For purposes of this embodiment of the invention, only certain ones of these layers are relevant to the determination of the size-dependent effects of layout features. In process 34, therefore, the information associated with certain layers of interest, for example including the active region layers (both n-type and p-type) and the gate layer (e.g., polysilicon) are extracted from the retrieved layout data base.

According to this embodiment of the invention, the modeling of the effects of complex shaped source/drain regions is carried out on a transistor-by-transistor basis. Accordingly, workstation 51 selects a first transistor of interest in process 36, for which the effects of its source/drain region shapes will be modeled. For this selected transistor of interest, workstation 51 next interrogates the extracted gate and active region layers of the layout database, to identify certain “gate corners”, in process 38.

FIG. 5a illustrates, in plan view, the location of gate corners GC1 through GC4 for an example of a transistor of interest having gate electrode 18b overlying an active region that includes source/drain regions 20b′, 20c′. According to this embodiment of the invention, gate corners GC1 through GC4 correspond to those locations at which an edge of gate electrode 18b crosses an edge of its source and drain regions. As shown in FIG. 5a, gate corner GC1 is identified in process 38 as the point at which the edge of gate electrode 18b (i.e., the edge of gate electrode 18b as expressed in the extracted gate layer) crosses the “northernmost” (in the orientation shown in FIG. 5a) edge of source/drain region 20b′ (i.e., the edge of source/drain region 20b′ as expressed in the extracted active region layer). Gate corner GC2 similarly is identified, in process 38, at the point at which the edge of gate electrode 18b crosses the northernmost edge of source/drain region 20c′, and so on. According to this embodiment of the invention, the shape of source/drain regions 20b′, 20c′ of this transistor will be characterized from these gate corners GC1 through GC4.

In process 40, workstation 51 selects one of the gate corners identified in process 38, and begins “tracing” the edge of the corresponding active region to locate a first inflection point along that edge. According to this embodiment of the invention, an inflection point corresponds to a change in direction of the edge of the active region, or to a gate electrode overlying or crossing that active region. Decision 41 determines whether this inflection point corresponds to a corner in the source/drain region of the transistor of interest, or to the far edge of that source/drain region (i.e., the active region containing that source/drain region) or to another gate electrode (i.e., the gate electrode for a neighboring transistor sharing that same active region). Both the far edge of the active region and the edge of next gate electrode constitute the end of the active region associated with the transistor of interest. As such, decision 41 determines whether the active region of the transistor of interest has a complex shape that can affect the performance characteristics of that transistor, for the reasons described above relative to FIGS. 3b and 3c.

FIG. 5a pictorially illustrates this tracing process 40, for the example of the transistor with gate electrode 18b. As shown in FIG. 5a by the arrow extending from gate corner GC1, the tracing of process 40 follows the northernmost edge of source/drain region 20b′ until it reaches a turning point at inflection point IP1. In this case, inflection point IP1 is a corner in the shape of source/drain region 20b′, and is nearer to gate corner GC1 along this edge of source/drain region 20b′ than either an adjacent poly gate electrode (point NPG at the edge of gate electrode 18a of a neighboring transistor) or the far edge of the active region (point ARE at the far edge of source/drain region 20a′, which is in the same active region as source/drain region 20b′). As such, this inflection point IP1 indicates a complex shape of source/drain region 20b′.

It is contemplated that the “tracing” of process 40 can be performed by workstation 51 or another appropriate computing resource in any one of a number of ways, primarily depending on the manner in which the extracted layers express the various features of the transistor. If the active region layer containing source/drain region 20b′ is expressed in a format including vectors for its various edges, then tracing process 40 may be numerically performed by examining the corresponding vector extending from gate corner GC1 to inflection point IP1 (for the example of FIG. 5a), or by determining whether the vector endpoint at inflection point IP1 corresponds to either point NPG or point ARE. Alternatively, if the layers express these features by areas, or some sort of bit-mapped arrangement, tracing process 40 may alternatively be carried out by a sort of scan of those area-based representations. The term “tracing” in this description is intended to refer to any such computer-implemented process by way of which the corresponding inflection point is identified from the retrieved expression of layout information by workstation 51 or by the operative computing resource. In any case, it is contemplated that those skilled in the art will be able to realize the appropriate function for tracing process 40 for their particular implementation.

Referring back to FIG. 4 for the example of FIG. 5a, because the inflection point IP1 is neither an edge of an adjacent poly gate or the far edge of the active region (decision 41 is “no”), workstation 51 executes process 42 to identify a jog space distance JS₁. FIG. 5b illustrates, in plan view, a portion of the transistor shown in FIG. 5a, illustrating the determination of jog space distance JS₁ in this example. As shown in FIG. 5b, tracing process 40 identifies the edge of source/drain region 20b′ beginning from gate corner GS1, and seeks an inflection point along that edge. In the example of FIG. 5b, the first inflection point IP1 found by tracing process 40 is inflection point IP1, which decision 41 determines is neither an edge (NPG) of a next poly gate nor the far edge (ARE) of the active region. Jog space distance JS₁ is identified, in process 42, as the distance from gate corner GC1 to this first inflection point IP1, and stored in memory.

Referring back to FIG. 4, workstation 51 next executes process 44 to trace the edge of the active region to a next inflection point. As described above, tracing process 44 may be performed in various ways, such as by evaluating a vector, scanning a layout representation, or the like. In typical layouts of modern integrated circuits, edges of active regions are generally defined as straight-line edges that run parallel or perpendicular to gate structures, as shown in FIGS. 5a and 5b. Accordingly, in this typical example as shown in FIG. 5b, tracing process 44 evaluates the edge of source/drain region 20b′ in a direction parallel to the edge of gate electrode 18b, until inflection point IP2 is reached. In process 46, jog height distance JH₁ between the first inflection point IP1 and the second inflection point IP2 identified by tracing process 44 is identified and stored in memory. In this embodiment of the invention, jog height distance JH₁ is a signed value, to indicate the direction in which inflection point IP2 lies relative to inflection point IP1. This signed value indicates whether the volume effect of eSiGe source/drain region 20b′ is increased by the jog (e.g., as in the case of FIG. 3b) or decreased (e.g., as in the case of FIG. 3c).

For the case in which the shape of the active region is constrained to permit at most only a single perpendicular jog for each gate corner GC, as in the case of source/drain region 20b′ of FIG. 5b, tracing processes 40, 44 are sufficient to characterize the volume effect of this shape by way of jog space distance JS₁ and jog height distance JH₁. Control can then pass to decision 45 to determine whether additional gate corners remain to be evaluated in this manner. However, it is contemplated that some design rules may allow more complex shapes for the active region, and thus more complex volume effects on transistor channel regions. It is further contemplated that those skilled in the art having reference to this specification will be readily able to construct an automated routine based on that described above to characterize those more complex geometries.

Referring back to decision 41 of FIG. 4, if the first inflection point identified by tracing process 40 corresponded to either an adjacent poly gate electrode NPG or the active region far edge ARE, decision 41 would return a “no” result. In process 43, workstation 51 would store zero values for jog space distance JS₁ and jog height distance JH₁, meaning that no volume effect other than the nominal physical channel width CW_{b} will affect the transistor channel region (at least for gate corner GC₁ in this example). Control then also passes in this case to decision 45.

In decision 45, workstation 51 determines whether additional gate corners GC remain to be analyzed in this fashion. If so (decision 45 is “yes”), then the next gate corner (e.g., gate corner GC₂) is selected and tracing process 40 commences from that selected gate corner GC.

Upon all gate corners GC for the transistor of interest having been evaluated (decision 45 is “no”), the layout-dependent parameters that account for these complex shape active regions have been extracted by process 10a. Workstation 51 next executes process 12 to derive adjusted performance parameters for the transistor of interest, based on the jog space distances JS and jog height distances JH that were identified and stored in memory in the instances of processes 42, 46 for that transistor. The transistor performance parameters derived in process 48 include those parameters that are affected by the size of source/drain regions 20, beyond that reflected simply by the physical channel width CW. As mentioned above, one such parameter for p-channel MOS transistors is the carrier mobility μₚ, which of course is the transistor performance parameter that the use of eSiGe in the source/drain regions is intended to enhance. Other parameters include the threshold voltage of the transistor, the saturation velocity of the transistor, and the drain/source resistance of the transistor in its “on” state.

According to embodiments of this invention, the size-dependent effects of layout parameters on these transistor performance parameters may be applied in various ways. For example, a simple multiplier may be used to adjust the transistor parameter, with the multiplier value being a function of the jog space distances JS and jog height distances JH. In this case, workstation 51 calculates an initial value for the parameter in the conventional manner, and then adjusts that calculated value based on the jog space distances JS and jog height distances JH. For example, if the initial carrier mobility value μₚ₀ is calculated for the transistor of FIGS. 5a and 5b, process 48 would adjust this value for the size-dependent layout effects by multiplying an adjustment factor κ to arrive at a final mobility value μ_{pF}:

μ_{pF}=κ·μₚ₀

where adjustment factor κ is a function of jog space distances JS and jog height distances JH:

κ=ƒ(JS₁, JH₁; JS₂, JH₂; JS₃, JH₃; JS₄, JH₄)

for the transistor of FIGS. 5a and 5b having four gate corners GC1 through GC4, as typical in the art. The particulars of the function defining adjustment factor κ can be determined from experimentation and characterization, or from theory. Alternatively, a more rigorous expression for the transistor performance parameters that are affected by the volume of the eSiGe source/drain regions 20 may be derived, again from theory or experimentation and characterization, and evaluated in process 12 for the transistor of interest. In any case, the evaluated transistor performance parameters from process 12 for the transistor of interest are stored in memory. It is contemplated that those skilled in the art having reference to this specification can readily implement the appropriate manner in which selected transistor performance parameters are derived or adjusted according to the layout features evaluated according to this embodiment of the invention, as applicable to particular device technology and modeling software.

Decision 49 is then executed by workstation 51, to determine whether other transistors in the integrated circuit layout remain to be evaluated and modeled by this process. If so (decision 49 is “yes”), control returns to process 36 in which the next transistor of interest is selected, and process 10a is then repeated. If all transistors to be modeled have been modeled at this point (decision 49 is “no”), then the derived transistor performance parameters from the executed instances of process 12 are then forwarded to simulation process 14 (FIG. 2) for design verification, circuit debugging, or the like in the usual manner.

Modeling Effects of Active Regions in Proximity to a Transistor

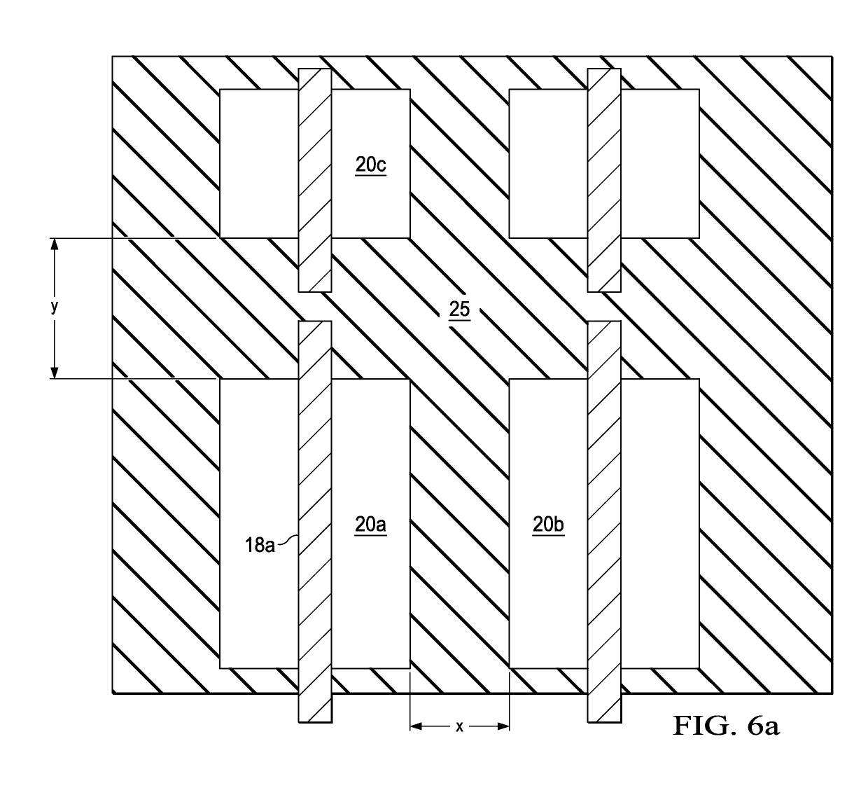

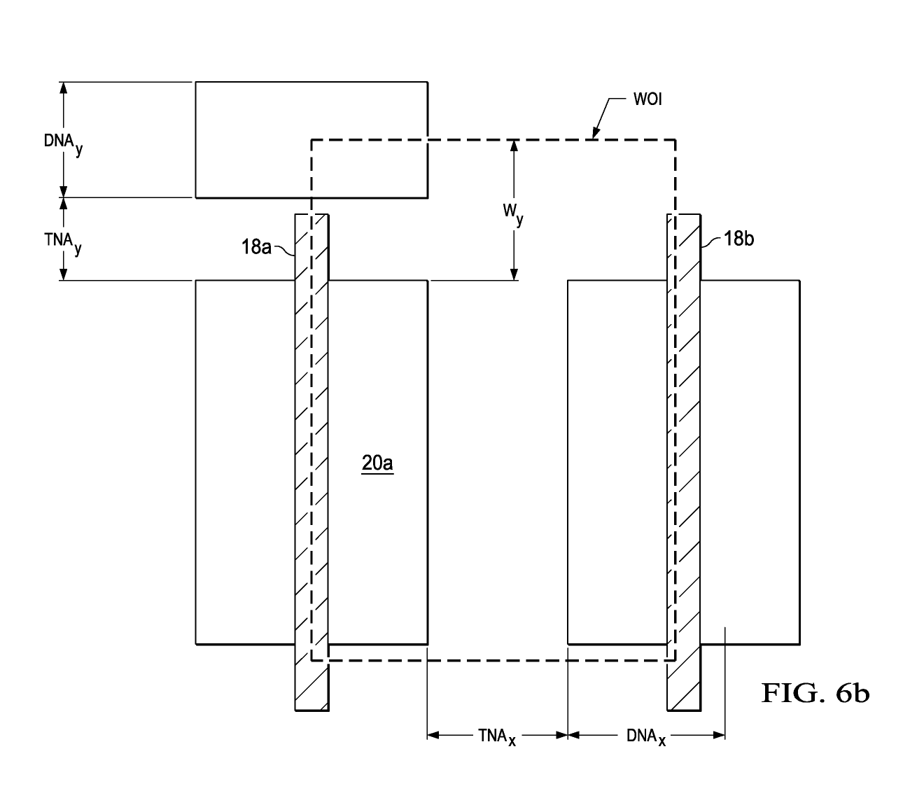

Extraction process 10 can additionally or alternatively include the analysis of the layout of transistors in an integrated circuit to determine the size-dependent effects of features in neighboring devices. FIG. 6a illustrates an example of these layout features from neighboring devices, as they may affect the performance of a MOS transistor; of course, other effects from neighboring devices may also come into play, and can be evaluated and included in the device model according to this embodiment of the invention.

FIG. 6a illustrates a group of neighboring MOS transistors, each having its own active region 20 that is separated from the active regions 20 of the neighboring devices by shallow trench isolation structures 25. For example, the transistor defined by gate electrode 18a has an active region 20a that has two neighboring active regions 20b, 20c. Active region 20b is a neighbor to active region 20a in the “x” direction in this example, and active region 20c is a neighbor to active region 20a in the “y” direction. These various active regions 20 can be of the same or opposite conductivity type, depending on the boundaries of the wells into which they are formed.

One effect exerted by these neighboring active regions 20b, 20c results from stresses within the intervening shallow trench isolation structures 25. As known in the art, shallow trench isolation structures 25 are typically formed by a masked recess etch into the surface of the substrate (or silicon layer in a silicon-on-insulator environment), followed by deposition of a dielectric film such as silicon dioxide into those recesses. The deposited silicon dioxide can exhibit compressive or tensile properties, which because of its presence in recesses into the silicon, can impart strain to the neighboring active regions. For example, shallow trench isolation structures 25 formed of compressive silicon dioxide can exert a compressive strain on the neighboring active regions and nearby channel regions. This strain caused by shallow trench isolation structures 25 is reduced for a given transistor if a relatively large active region of a neighboring transistor is nearby. Referring to the example of FIG. 6a, the compressive strain on the channel region underlying gate electrode 18a is thus affected by the proximity and depth of active region 20b in the “x” direction as shown. As discussed above, this compressive strain in a direction parallel to source-drain conduction (i.e., perpendicular to gate electrode 18a) enhances carrier mobility for p-channel MOS transistors and degrades carrier mobility for n-channel MOS transistors.

Another layout and size dependent effect results from active regions in neighboring devices in the “y” direction (referring to the example of FIG. 6a). For shallow trench isolation structures 25 formed of compressive silicon dioxide, compressive strain in a direction perpendicular to source-drain conduction (i.e., parallel to gate electrode 18b) degrades MOS transistor performance. As such, the extent to which this strain is reduced by nearby large active regions, such as active region 20c relative to active region 20a.

As mentioned above, dual stress liner (DSL) technology is now available, by way of which both n-channel and p-channel transistor performance is enhanced in modern integrated circuits. According to this technology, tensile silicon nitride is formed over source and drain regions of n-channel transistors, and compressive silicon nitride is formed over source and drain regions of p-channel transistors. These dual stress liners apply tensile and compressive strain to the channel regions of n-channel and p-channel transistors, respectively, enhancing carrier mobility in each case. However, the strain induced by these stress liners can also be transmitted to nearby active regions of neighboring transistors, depending on the volume and proximity of the active regions involved.

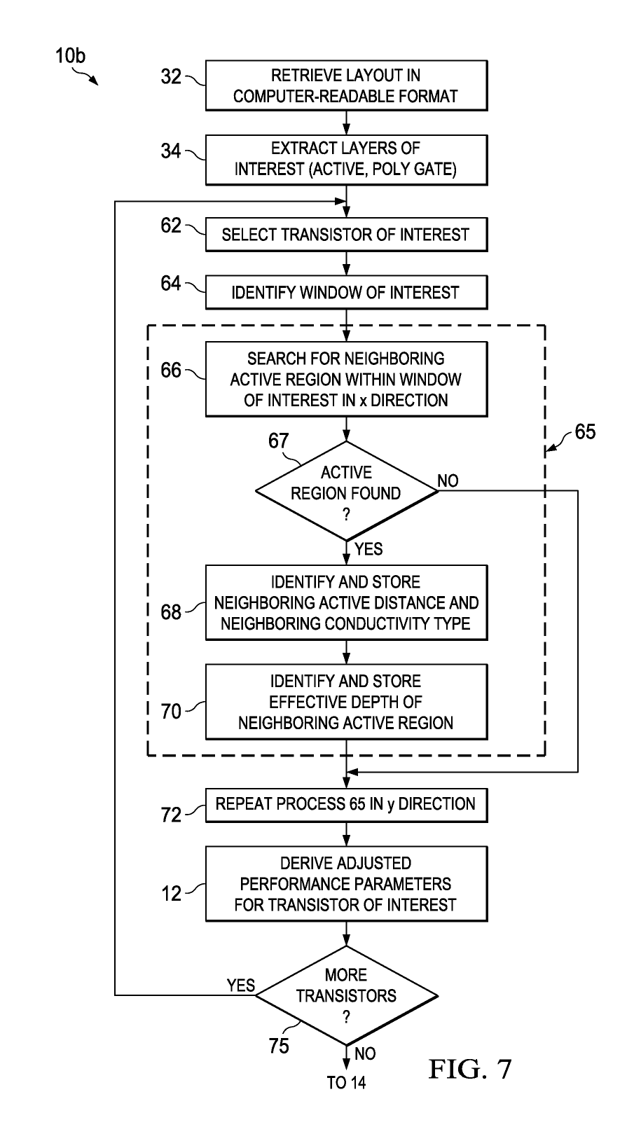

According to embodiments of this invention, the proximity (in both directions) and size of neighboring active regions to those of a transistor of interest are evaluated and included into the transistor model. The operation of modeling and simulation system 50 evaluates these factors by executing layout extraction process 10b, which will now be described in detail with reference to FIG. 7. Process 10b can be incorporated within extraction process 10 (FIG. 2) in addition to the layout extraction process 10a described above in connection with FIG. 4, as desired by the appropriate personnel for a given technology. In any case, as mentioned above, it is contemplated that computing resources in modeling and simulation system 50 will carry out process 10b executing computer program instructions, whether stored locally in one or more memory resources operating as programmed memory or by way of invoking the execution of a web-based application, or the like. In this description, extraction process 10b will be described as executed, in large part, by workstation 51, although it will be understood that other computing resources in modeling and simulation system 50 can alternatively perform these operations.

As in the case of process 10a, process 10b begins with process 32, in which a computer-readable expression of the layout of at least a portion of an integrated circuit is retrieved. In process 34, the information associated with certain layers of interest, for example including the active region layers (both n-type and p-type) and the gate layer (e.g., polysilicon) are extracted from the retrieved layout data base. These processes 32, 34 are performed in the same manner as described above relative to FIG. 4; indeed, these processes 32, 34 may have already been performed if other layout extraction functions (e.g., as described above relative to FIG. 4) have been previously executed.

According to this embodiment of the invention, the effects of neighboring active regions are modeled on a transistor-by-transistor basis, and as such this process begins with process 62, in which workstation 51 selects a transistor of interest for analysis. In process 64, workstation 62 selects a “window of interest”, which corresponds to the boundaries of the layout that will be scanned or otherwise analyzed for neighboring active regions. This window of interest can be a particular distance from a feature of the transistor of interest (e.g., from gate electrode 18a, or from the far edge of source/drain region 20a), or may be defined as a given feature of a neighboring device regardless of the distance away. FIG. 6b illustrates an example of window of interest WOI for the transistor defined by gate electrode 18a, which extends from the center line of gate electrode 18a perpendicularly from gate electrode 18a and extending to the near edge of gate electrode 18b; window of interest WOI in the direction parallel to gate electrode 18a in this example extends from the far edge of source/drain region 20a for a selected distance W_{y}, as shown. The extent of this window of interest WOI is contemplated to be on the order of the farthest distance of observable neighboring active region effects on a transistor, for a given technology. For example, such a distance may be on the order of 2 μm for modern CMOS technology.

In this embodiment of the invention, process 65 is next executed by workstation 51 to evaluate nearby active regions in the “x” direction (i.e., in a direction parallel to source-drain conduction for the transistor of interest). This process 65 begins with process 66, in which the layout information in one or more extracted layers including n-type and p-type active regions is searched to determine whether any portion of an active region in a neighboring device is present within window of interest WOI. The searching of process 66 can be carried out in any one of a number of ways, including scanning of layout information and the like. Decision 67 determines whether a neighboring active region in this “x” direction is found. If so (decision 67 is “yes”), workstation 51 executes process 68 to determine the distance to this adjacent active region, and stores that distance in memory, and also the conductivity type of that neighboring active region if desired. Referring to FIG. 6b, distance TNAₓ refers to the distance from the far edge of active region 20a to the near edge of neighboring active region 20b in the “x” direction. In this example, this distance TNAₓ is stored in memory in process 68, along with the conductivity type of active region 20b if desired.

In process 70, workstation 51 analyzes the effective depth of this neighboring active region 20b from its near edge. In this embodiment of the invention, this effective depth can be derived as the actual depth of the active region extending from its near edge to its far edge (which may or may not include any overlying gate electrodes, depending on the physical effect to be modeled), up to a maximum depth (beyond which the effective depth can be assumed as infinite for the parameter being modeled). FIG. 6b illustrates an example of effective depth measurement DNAₓ, extending in the “x” direction from the edge of active region 20b nearest to the transistor of interest, and extending to its maximum depth including overlying gate electrode 18b. This effective depth DNAₓ is also stored in memory by workstation, in process 70.

In process 72, workstation 72 repeats the operations of process 65, but in the orthogonal (e.g., “y”) direction to that for which process 65 was performed. Similarly and with reference to the example of FIG. 6b, if a neighboring active region (such as active region 20c) is found within window of interest WOI, workstation 51 determines and stores the distance TNA_{y} to the near edge of that neighboring active region 20c from the far edge of active region 20a, the effective depth DNA_{y} of that active region 20c, and also the conductivity type of that neighboring active region 20c.

After neighboring active regions have been identified and their relevant distances, depths, and conductivity types stored in memory, workstation 51 next executes process 12 to derive adjusted performance parameters for the transistor of interest, based on the identified distances TNA, depths DNA, and conductivity types of any neighboring active regions discovered in this process. As before, it is contemplated that the transistor performance parameters derived in process 12 will include carrier mobility, threshold voltage, saturation velocity, and on-state drain/source resistance. And as before, values for these parameters may be derived in process 12 by adjusting nominal or previously-calculated values by a factor based on a function of the distances and depths (and conductivity type, if appropriate) identified in processes 65, 72, or alternatively by evaluation of a rigorous expression for those parameters including those layout-dependent values. These parameters are then stored in memory for the transistor of interest.

In decision 75, workstation 51 determines whether other transistors in the integrated circuit layout remain to be similarly evaluated and modeled. If so (decision 75 is “yes”), control returns to process 62 for selection of the next transistor of interest, and the process is repeated. If not (decision 75 is “no”), the transistor performance parameters derived from the instances of process 12 are forwarded to simulation process 14 (FIG. 2) for design verification, circuit debugging, or the like in the usual manner.

Simulation

As described above in connection with FIG. 2, simulation process 14 evaluates the response of the modeled transistors to simulated stimuli as desired for the particular purpose of design verification, debugging, and the like. Conventional simulation programs, such as the well-known variations of the Simulation Program with Integrated Circuit Emphasis (SPICE), and the like, may be used in connection these embodiments of the invention. As mentioned above, simulation process 14 can perform DC simulation (i.e., steady-state or operating point determination), AC simulation (i.e., small-signal response), transient response simulation, or a combination of these simulations, as desired by the responsible personnel.

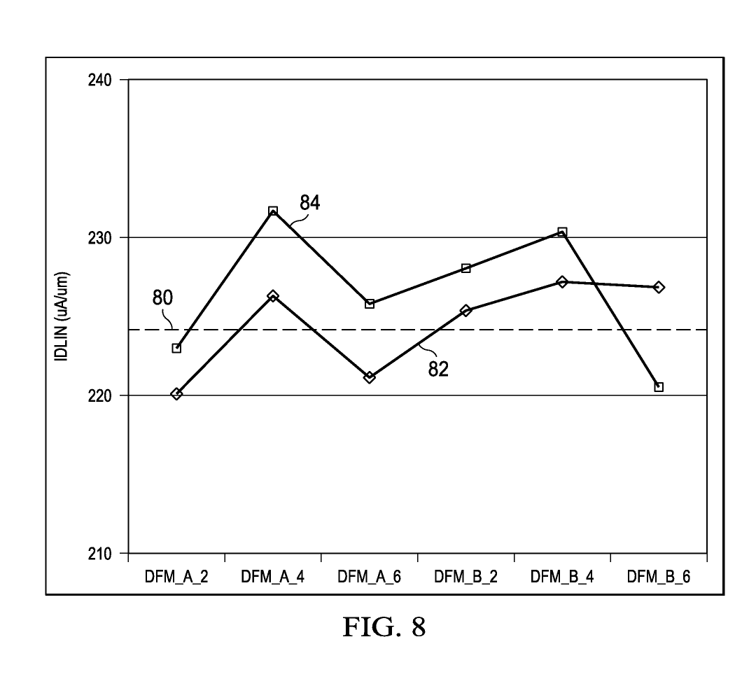

It has been observed that the layout parameter extraction of process 10 and the application of these layout parameters to transistor models in process 12, as described above, result in a more accurate simulation that accounts for the layout-dependent effects, particularly regarding strain on MOS transistor channel regions due to these various features. FIG. 8 illustrates a comparative example of these improved results, for six MOS transistors of various layout construction (indicated along the x-axis of FIG. 8).

In FIG. 8, plot 80 illustrates the simulated linear drain-source current for these six transistors, as based on conventional transistor models in which the transistor performance parameters do not take into account the layout-dependent effects of complex shape active regions or neighboring active regions. As evident from plot 80, because these layout-dependent effects are not included in the model, the simulated linear drain-source current is constant among these six transistors. Unfortunately, the actual linear drain-source current (for a given bias condition) measured for these transistors varies due to variations in the layout environments of these transistors, as shown by plot 82 in FIG. 8. Comparison of plots 80 and 82 thus illustrate a significant discrepancy in the resulting simulation.

Plot 84 illustrates the simulated linear drain-source current for these six transistors, using models for transistor performance parameters that take into account layout-dependent effects according to embodiments of this invention. As evident from FIG. 8, the simulation results of plot 84 generally track the measured current of plot 82, thus incorporating the layout-dependent effects into the simulation that conventional modeling (as evident by straight-line plot 80) do not.

According to embodiments of this invention a system and method is provided by way of which layout-dependent features, including complex and irregular layout features of active regions of a transistor being modeled, and also strain effects caused by neighboring active regions to the transistor being modeled, are detected and characterized for their effects on transistor performance. The resulting model is thus more accurate in predicting the performance and operation of integrated circuits being designed, allowing for improved detection of circuit issues prior to fabrication of actual devices and thus shortening the design-to-product cycle.

While this invention has been described according to certain embodiments, it is of course contemplated that modifications of, and alternatives to, these embodiments, such modifications and alternatives obtaining the advantages and benefits of this invention, will be apparent to those of ordinary skill in the art having reference to this specification and its drawings. It is contemplated that such modifications and alternatives are within the scope of this invention as subsequently claimed herein.

What is claimed is:

1. A method of operating a computer system to create a model of a transistor for use in a computerized simulation of an electronic circuit including the transistor, comprising the steps of:
retrieving stored physical layout data associated with one or more physical layers of at least a portion of the integrated circuit including the transistor;
from the retrieved layout data, extracting at least one size-dependent layout parameter value affecting channel region strain for the transistor;
calculating a value for a first transistor performance model parameter for the transistor based on the extracted size-dependent layout parameter value; and
storing the first transistor performance model parameter value in memory.

2. The method of claim 1, wherein the extracting step comprises:
from the retrieved layout data associated with a gate layer and an active layer, identifying crossing locations at which a gate electrode crosses active region boundaries of the transistor;
tracing retrieved layout data associated with the active layer along an edge of the active region from a first crossing location, to identify the location of a first inflection point of the active region associated with the transistor;
responsive to the first inflection point located nearer to the gate electrode than a far edge of the active region associated with the transistor, tracing retrieved layout data associated with the active layer along an edge of the active region from the first inflection point, to identify the location of a second inflection point;
then determining a jog space distance perpendicularly from the gate electrode at the first crossing location to the first inflection point; and
then determining a jog height distance in a direction parallel to the gate electrode from the first inflection point to the second inflection point;
wherein the at least one size-dependent layout parameter value comprise the identified jog space distance and jog height distance.

3. The method of claim 2, wherein the step of calculating the first transistor performance model parameter value comprises:
retrieving a value for the first transistor performance model parameter that is not dependent on jog space distance or jog height distance;
applying an adjustment factor to the first transistor performance model parameter responsive to the jog space distance and jog height distance;
and further comprising:
responsive to the first inflection point located no nearer to the gate electrode than a far edge of the active region associated with the transistor, calculating the adjustment factor as applying no adjustment to the first retrieved transistor model parameter value.

4. The method of claim 2, further comprising:
repeating the tracing and determining steps for each of a plurality of crossing locations.

5. The method of claim 4, wherein the calculating step calculates the adjustment factor responsive to the jog space distance and jog height distance determined for each of the crossing locations.

6. The method of claim 2, wherein the jog height distance has a signed value, with the sign corresponding to the direction of travel of the tracing of retrieved layout data from the second inflection point.

7. The method of claim 1, wherein the extracting step comprises:
from the retrieved layout data associated with a gate layer, identifying a window of interest including a region extending from the transistor;
interrogating retrieved layout data associated with an active layer, over the window of interest, to determine whether an edge of an active region associated with a neighboring device to the transistor is present within a selected distance from an active region associated with the transistor; and
responsive to determining that an edge of an active region associated with the neighboring device is present within the selected distance, identifying an effective depth of the active region at that location and a distance of the active region from a nearest edge of the active region associated with the transistor, from the retrieved layout data;
wherein the at least one size-dependent layout parameter value comprise the identified depth and distance.

8. The method of claim 7, further comprising:
from the retrieved layout data associated with the gate layer, identifying the direction of a gate structure crossing an active region in the transistor;
wherein the interrogating step interrogates the retrieved layout data in a first direction parallel to the direction of the gate structure in the transistor;
and further comprising:
interrogating retrieved layout data associated with an active layer, over the window of interest and in a second direction perpendicular to the direction of the gate structure in the transistor, to determine whether an edge of an active region associated with a neighboring device to the transistor is present within a selected distance in the second direction from the active region associated with the transistor;
responsive to determining that an edge of an active region associated with the neighboring device is present within the selected distance in the second direction, identifying an effective depth of the active region at that location in the second direction and a distance of the active region in the second direction from a nearest edge of the active region associated with the transistor, from the retrieved layout data;
calculating a value for a second transistor performance model parameter value for at least one transistor parameter for the transistor from the identified depth and distance in the second direction;
storing the second transistor performance model parameter value in memory.

9. The method of claim 7, further comprising:
responsive to determining that an edge of an active region associated with the neighboring device is present within the selected distance, determining the conductivity type of the active region associated with the neighboring device, from the retrieved layout data;
wherein the first transistor performance model parameter value is also calculated based on the determined conductivity type of the active region.

10. The method of claim 7, wherein the identifying step identifies the window of interest extending from the transistor to a gate structure of a neighboring device to the transistor.

11. The method of claim 7, wherein the identifying step identifies the effective depth by:
determining the depth of the active region of the neighboring device from the identified edge, up to a maximum depth value;
wherein the effective depth is the smaller of the determined depth and the maximum depth value.

12. The method of claim 1, wherein the transistor performance model parameter is selected from the group consisting of carrier mobility, threshold voltage, saturation velocity, and drain-to-source on resistance.

13. A computer-readable medium storing a computer program that, when executed on a computer system, causes the computer system to perform a sequence of operations for creating a model of a transistor for use in a computerized simulation of an electronic circuit including the transistor, the sequence of operations comprising:
retrieving stored physical layout data associated with one or more physical layers of at least a portion of the integrated circuit including the transistor;
from the retrieved layout data, extracting at least one size-dependent layout parameter value affecting channel region strain for the transistor;
calculating a value for a first transistor performance model parameter for the transistor based on the extracted size-dependent layout parameter value; and
storing the first transistor performance model parameter value in memory.

14. The computer-readable medium of claim 13, wherein the extracting operation comprises:
from the retrieved layout data associated with a gate layer and an active layer, identifying crossing locations at which a gate electrode crosses active region boundaries of the transistor;
tracing retrieved layout data associated with the active layer along an edge of the active region from a first crossing location, to identify the location of a first inflection point of the active region associated with the transistor;
responsive to the first inflection point located nearer to the gate electrode than a far edge of the active region associated with the transistor, tracing retrieved layout data associated with the active layer along an edge of the active region from the first inflection point, to identify the location of a second inflection point;
then determining a jog space distance perpendicularly from the gate electrode at the first crossing location to the first inflection point; and
then determining a jog height distance in a direction parallel to the gate electrode from the first inflection point to the second inflection point;
wherein the at least one size-dependent layout parameter value comprise the identified jog space distance and jog height distance.

15. The computer-readable medium of claim 14, further comprising:
repeating the tracing and determining operations for each of a plurality of crossing locations;
wherein the calculating operation calculates the adjustment factor responsive to the jog space distance and jog height distance determined for each of the crossing locations.

16. The computer-readable medium of claim 14, wherein the jog height distance has a signed value, with the sign corresponding to the direction of travel of the tracing of retrieved layout data from the second inflection point.

17. The computer-readable medium of claim 13, wherein the extracting operation comprises:
from the retrieved layout data associated with a gate layer, identifying a window of interest including a region extending from the transistor;
interrogating retrieved layout data associated with an active layer, over the window of interest, to determine whether an edge of an active region associated with a neighboring device to the transistor is present within a selected distance from an active region associated with the transistor; and
responsive to determining that an edge of an active region associated with the neighboring device is present within the selected distance, identifying an effective depth of the active region at that location and a distance of the active region from a nearest edge of the active region associated with the transistor, from the retrieved layout data;
wherein the at least one size-dependent layout parameter value comprise the identified depth and distance.

18. The computer-readable medium of claim 17, further comprising:
from the retrieved layout data associated with the gate layer, identifying the direction of a gate structure crossing an active region in the transistor;
wherein the interrogating step interrogates the retrieved layout data in a first direction parallel to the direction of the gate structure in the transistor;
and further comprising:
interrogating retrieved layout data associated with an active layer, over the window of interest and in a second direction perpendicular to the direction of the gate structure in the transistor, to determine whether an edge of an active region associated with a neighboring device to the transistor is present within a selected distance in the second direction from the active region associated with the transistor;
responsive to determining that an edge of an active region associated with the neighboring device is present within the selected distance in the second direction, identifying an effective depth of the active region at that location in the second direction and a distance of the active region in the second direction from a nearest edge of the active region associated with the transistor, from the retrieved layout data;
calculating a value for a second transistor performance model parameter value for at least one transistor parameter for the transistor from the identified depth and distance in the second direction;
storing the second transistor performance model parameter value in memory.

19. The computer-readable medium of claim 17, further comprising:
responsive to determining that an edge of an active region associated with the neighboring device is present within the selected distance, determining the conductivity type of the active region associated with the neighboring device, from the retrieved layout data;
wherein the first transistor performance model parameter value is also calculated based on the determined conductivity type of the active region.

20. A simulation system, comprising:
a memory resource;
input and output functions for receiving inputs from and presenting communication signals to a human user;
a processor for executing program instructions; and
program memory, coupled to the central processing unit, for storing a computer program including program instructions that, when executed by the processor, cause the computer system to perform a plurality of operations for creating a model of a transistor for use in a computerized simulation of an electronic circuit including the transistor, the sequence of operations comprising:
retrieving stored physical layout data associated with one or more physical layers of at least a portion of the integrated circuit including the transistor;
from the retrieved layout data, extracting at least one size-dependent layout parameter value affecting channel region strain for the transistor;
calculating a value for a first transistor performance model parameter for the transistor based on the extracted size-dependent layout parameter value; and
storing the first transistor performance model parameter value in memory.

21. The system of claim 13, wherein the extracting operation comprises:
from the retrieved layout data associated with a gate layer and an active layer, identifying crossing locations at which a gate electrode crosses active region boundaries of the transistor;
tracing retrieved layout data associated with the active layer along an edge of the active region from a first crossing location, to identify the location of a first inflection point of the active region associated with the transistor;
responsive to the first inflection point located nearer to the gate electrode than a far edge of the active region associated with the transistor, tracing retrieved layout data associated with the active layer along an edge of the active region from the first inflection point, to identify the location of a second inflection point;
then determining a jog space distance perpendicularly from the gate electrode at the first crossing location to the first inflection point; and
then determining a jog height distance in a direction parallel to the gate electrode from the first inflection point to the second inflection point;
wherein the at least one size-dependent layout parameter value comprise the identified jog space distance and jog height distance.

22. The system of claim 21, further comprising:
repeating the tracing and determining operations for each of a plurality of crossing locations;
wherein the calculating operation calculates the adjustment factor responsive to the jog space distance and jog height distance determined for each of the crossing locations.

23. The system of claim 21, wherein the jog height distance has a signed value, with the sign corresponding to the direction of travel of the tracing of retrieved layout data from the second inflection point.

24. The system of claim 20, wherein the extracting operation comprises:
from the retrieved layout data associated with a gate layer, identifying a window of interest including a region extending from the transistor;
interrogating retrieved layout data associated with an active layer, over the window of interest, to determine whether an edge of an active region associated with a neighboring device to the transistor is present within a selected distance from an active region associated with the transistor; and
responsive to determining that an edge of an active region associated with the neighboring device is present within the selected distance, identifying an effective depth of the active region at that location and a distance of the active region from a nearest edge of the active region associated with the transistor, from the retrieved layout data;
wherein the at least one size-dependent layout parameter value comprise the identified depth and distance.

25. The system of claim 24, further comprising:
from the retrieved layout data associated with the gate layer, identifying the direction of a gate structure crossing an active region in the transistor;
wherein the interrogating step interrogates the retrieved layout data in a first direction parallel to the direction of the gate structure in the transistor;
and further comprising:
interrogating retrieved layout data associated with an active layer, over the window of interest and in a second direction perpendicular to the direction of the gate structure in the transistor, to determine whether an edge of an active region associated with a neighboring device to the transistor is present within a selected distance in the second direction from the active region associated with the transistor;
responsive to determining that an edge of an active region associated with the neighboring device is present within the selected distance in the second direction, identifying an effective depth of the active region at that location in the second direction and a distance of the active region in the second direction from a nearest edge of the active region associated with the transistor, from the retrieved layout data;
calculating a value for a second transistor performance model parameter value for at least one transistor parameter for the transistor from the identified depth and distance in the second direction;
storing the second transistor performance model parameter value in memory.

26. The system of claim 24, further comprising:
responsive to determining that an edge of an active region associated with the neighboring device is present within the selected distance, determining the conductivity type of the active region associated with the neighboring device, from the retrieved layout data;
wherein the first transistor performance model parameter value is also calculated based on the determined conductivity type of the active region.
